(19) United States
(12) Patent Application Publication
(10) Pub. No.: US 2014/0285448 A1
(43) Pub. Date: Sep. 25, 2014

(54) TOUCH SENSING DEVICE AND DRIVING METHOD THEREOF

(71) Applicant: Samsung Display Co., Ltd., Yongin-City (KR)

(72) Inventor: Hee Joon KIM, Yongin-si (KR)

(73) Assignee: Samsung Display Co., Ltd., Yongin-City (KR)

(21) Appl. No.: 14/066,559

(22) Filed: Oct. 29, 2013

(30) Foreign Application Priority Data
Mar. 25, 2013 (KR) 10-2013-0031739

(51) Int. Cl. G06F 3/041

(52) U.S. Cl. CPC G06F 3/041
USPC 345/173

(57) ABSTRACT

A method of driving a touch sensing device, the touch sensing device including a sensor including a switching element, a sensing signal line connected with the sensor, an amplifier connected with the sensing signal line, a reset switch and a capacitor connected between an input terminal and an output terminal of the amplifier, and a sample and hold switch and a sample and hold capacitor that are connected to the output terminal of the amplifier, the method including: outputting a sensing signal to the sensing signal lines by turning on the switching element during a first period according to a scan signal; and turning on the sample and hold switch during a second period occurring within the first period.

### CROSS-REFERENCE TO RELATED APPLICATION

This application claims priority to and the benefit of Korean Patent Application No. 10-2013-0031739 filed in the Korean Intellectual Property Office on Mar. 25, 2013, the entire contents of which are incorporated herein by reference.

### BACKGROUND

(a) Technical Field

The present invention relates to a touch sensing device and a driving method thereof, and more particularly, to a touch sensing device including a charge sensitive sensor, and a driving method thereof.

(b) Description of the Related Art

A sensor may output a sensing signal by sensing a change in an external environment, for example a touch. The sensing signal then provides information on the change in the external environment, such as information about the touch.

One type of sensor, referred to as a charge sensitive sensor, includes a sensing element and a capacitor connected to the sensing element, and generates a sensing signal when there is a change in a charge of the capacitor.

An optical sensor is a sensor that senses a change in light, and may be formed of a transistor, which is a three-terminal device, in general. The optical sensor may generate a sensing signal by using photoelectric current generated by light incident on a channel unit of the transistor, and obtain touch information by using the sensing signal. The light sensed by the optical sensor may be light with various frequencies, such as infrared light and visible light.

In general, when a charge sensitive sensor outputs a sensing signal, the outputted sensing signal is integrated and converted during a predetermined period, so that information about the touch is generated.

In the meantime, a touch sensing device may be implemented in various forms, and for example, a display device having a touch sensing function and an image sensing function has been developed.

In general, a display device having a touch sensing function may be formed by attaching a touch screen panel capable of sensing a touch to a display panel. However, such a touch sensing display device has problems of a cost increase, a decrease in a yield due to the addition of a bonding process, and deterioration of luminance of the display panel. Accordingly, a technique for embedding a sensor formed of a thin film transistor or a capacitor in a display area displaying an image of a display device has been developed. In the case of a display device including an optical sensor, a light source of light sensed by the optical sensor may be positioned inside the display device. For example, a backlight, which is an internal light source for displaying an image of the display device, may be configured so as to emit light with a wavelength appropriate to the optical sensor together with visible light.

The above information disclosed in this Background section is only for enhancement of understanding of the background and therefore it may contain information that does not form the prior art that is already known to a person of ordinary skill in the art.

### SUMMARY

A touch sensing device capable of reading out a sensing signal at a high speed, and a driving method thereof are provided.

A method of driving a touch sensing device, the touch sensing device including a sensor including a switching element, a sensing signal line connected with the sensor, an amplifier connected with the sensing signal line, a reset switch and a capacitor connected between an input terminal and an output terminal of the amplifier, and a sample and hold switch and a sample and hold capacitor that are connected to the output terminal of the amplifier, the method comprising: outputting a sensing signal to the sensing signal lines by turning on the switching element during a first period according to a scan signal; and turning on the sample and hold switch during a second period occurring within the first period.

A start point of the second period may be later than a start point of the first period, and a termination point of the second period may be earlier than a termination point of the first period.

At least one of a time difference between the start point of the second period and the start point of the first period and a time difference between the termination point of the second period and the termination point of the first period may be equal to or larger than approximately 0.5 μs.

The method may further include turning on the reset switch during a third period occurring before the start point of the first period.

The reset switch may reset both terminals of the capacitor with a reference voltage during the third period.

The reference voltage may be in a range from approximately 2.7 V to approximately 3.3 V.

The sensor may further include a sensing element and a sensing capacitor that are connected with the switching element.

In another aspect, a touch sensing device includes a sensor including a switching element outputting a sensing signal according to a scan signal; a sensing signal line connected with the switching element of the sensor and transfer the sensing signal; an amplifier connected with the sensing signal line; a reset switch and a capacitor connected between an input terminal and an output terminal of the amplifier; and a sample and hold switch and a sample and hold capacitor that are connected to the output terminal of the amplifier, in which a second period in which the sample and hold switch is turned on occurs within a first period in which the switching element is turned on.

A start point of the second period may be later than a start point of the first period, and a termination point of the second period may be earlier than a termination point of the first period.

At least one of a time difference between the start point of the second period and the start point of the first period and a time difference between the termination point of the second period and the termination point of the first period may be equal to or larger than approximately 0.5 μs.

A third period in which the reset switch is turned on may occur before the start point of the first period.

The reset switch may reset both terminals of the capacitor with a reference voltage during the third period.

The reference voltage may be in a range from approximately 2.7 V to approximately 3.3 V.

The sensor may further include a sensing element and a sensing capacitor that are connected with the switching element.

According to the exemplary embodiments, it is possible to drive a touch sensing device including a sensor at a high speed by decreasing a time necessary for a sensing operation using a sensing signal from the sensor. Accordingly, it is possible to improve a touch feeling of the touch sensing device including the sensor.

### BRIEF DESCRIPTION OF THE DRAWINGS

FIG. 1 is a layout view of a touch sensing device including a sensor according to an exemplary embodiment.

FIG. 2 is a circuit diagram of the sensor and a sensing signal processor according to an exemplary embodiment.

FIG. 3 is a waveform diagram of a driving signal of the sensor and the sensing signal processor according to an exemplary embodiment.

FIG. 4 is a circuit diagram of a reset step of the sensor and the sensing signal processor according to an exemplary embodiment.

FIG. 5 is a circuit diagram of an output step of the sensor and the sensing signal processor according to an exemplary embodiment.

FIG. 6 is a waveform diagram of a driving signal and a sensing output signal of the sensor and the sensing signal processor in a case where light is not irradiated to the sensor according to an exemplary embodiment.

FIG. 7 is a waveform diagram of a driving signal and a sensing output signal of the sensor and the sensing signal processor in a case where light is irradiated to the sensor according to an exemplary embodiment.

FIG. 8 illustrates an image sensed by a sensor in the related art and an image sensed by the sensor according to an exemplary embodiment.

### DETAILED DESCRIPTION OF THE EMBODIMENTS

Exemplary embodiments will be described more fully hereinafter with reference to the accompanying drawings, in which exemplary embodiments are shown. As those skilled in the art would realize, the described embodiments may be modified in various different ways, all without departing from the spirit or scope of the present disclosure.

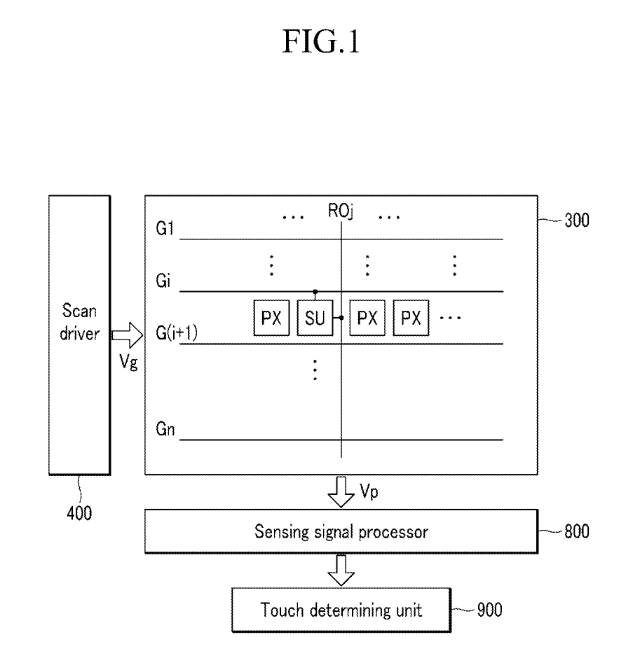

First, a touch sensing device according to an exemplary embodiment will be described with reference to FIG. 1.

FIG. 1 is a layout view of a touch sensing device including a sensor according to an exemplary embodiment.

The touch sensing device according to exemplary embodiments may be implemented as any one of several types of touch screen panels or display devices having a sensing function. FIG. 1 illustrates the touch sensing device implemented as a display device as an example.

Referring to FIG. 1, the touch sensing device according to an exemplary embodiment includes a touch panel 300, a scan driver 400, a sensing signal processor 800, and a touch determining unit 900.

The touch panel 300 includes a plurality of signal lines and one or more sensors SU connected to the plurality of signal lines.

The signal lines include a plurality of scan signal lines G1, . . . , Gi, G(i+1), . . . and Gn, and a plurality of sensing signal lines ROj. Here, n and j are natural numbers.

The scan signal lines G1, . . . , Gi, G(i+1), . . . and Gn may approximately extend in a row direction and be almost parallel to each other. The scan signal lines G1, . . . , Gi, G(i+1), . . . and Gn sequentially transfer a scan signal.

The sensing signal lines ROj may approximately extend in a column direction. The sensing signal lines ROj transmit sensing signals from the sensors SU to the sensing signal processor 800. A reference voltage Vf may be uniformly applied to the sensing signal lines ROj.

The sensors SU may generate sensing signals by sensing a touch, and be approximately arranged in a matrix form. The sensor SU, which is a charge sensitive sensor including a sensing capacitor, outputs a sensing signal which changes based on a change in a charge of the sensing capacitor caused by a touch to the sensing capacitor.

The sensor SU may be connected to at least one of the scan signal lines G1, . . . , Gi, G(i+1), . . . and Gn, and one sensing signal line ROj, and include at least one switching element. The sensor SU is operated according to a scan signal transferred by the scan signal lines G1, . . . , Gi, G(i+1), . . . and Gn, and transfers the sensing signal to the sensing signal line ROj.

According to an exemplary embodiment, the sensor SU may be an optical sensor that senses changes in light that occur when a touch occurs. In this case, the light sensed by the sensor SU may be light having a wavelength within a predetermined range. For example, the light sensed by the sensor SU may be visible light having a wavelength of approximately 300 nm to approximately 800 nm, or infrared light having a wavelength of approximately 800 nm to approximately 1100 nm. In a case where the sensor SU is a sensor sensing infrared light, the sensor SU may include a semiconductor formed of amorphous silicon germanium (a-SiGe) or amorphous germanium (a-Ge), and in a case where the sensor SU is a sensor sensing visible light, the sensor SU may include a semiconductor formed of amorphous silicon (a-Si).

The sensor SU according to an exemplary embodiment may sense one type of light, but a device including sensors SU may include a plurality of sensors SU sensing light with different wavelength bands. For example, an infrared light sensor capable of sensing infrared light and a visible light sensor unit capable of sensing visible light may be disposed together.

In a case where the touch sensing device according to an exemplary embodiment is a display device having a touch sensing function capable of displaying an image, the touch panel 300 may further include a plurality of pixels PX.

Each pixel PX may include a switching element and a pixel electrode (not illustrated) connected to the switching element. The switching element of the pixel PX may be connected with the scan signal lines G1, . . . , Gi, G(i+1), . . . and Gn, and may be connected with other signal lines different from the scan signal lines G1, . . . , Gi, G(i+1), . . . and Gn

In order to implement a color, each pixel PX may, for example, display one color among the primary colors, such as the three primary colors including red, green, and blue. The predetermined number of pixels PX displaying different colors may configure one dot. The plurality of pixels PX may be approximately arranged in a matrix form.

In a case where the touch panel 300 includes the plurality of pixels PX, the sensor SU may be disposed between the two adjacent pixels PX along the row direction, as illustrated in FIG. 1, or the column direction. A density of the sensors to the pixels PX in the row direction or the column direction may be variously controlled. For example, the density of the sensors SU may be approximately ⅓ of the density of the pixels PX, but is not limited thereto, and may be changed depending upon the resolution of sensing that is desired. As an alternative to the illustration of FIG. 1, the sensors SU may be positioned to overlap a part of the pixels PX.

In a case where the display device according to an exemplary embodiment includes a backlight unit, the sensor SU according to an exemplary embodiment may generate a sensing signal by sensing a touch or the approach of an exterior object, or the sensor SU may generate a sensing signal by sensing an image of the exterior object by using internal light emitted from the backlight unit. For example, the sensor SU may sense a touch or an image of the exterior object by using infrared light or visible light. In this case, when the exterior object approaches the touch panel 300 of the display device, the infrared light or the visible light from the backlight may be reflected from the exterior object and be incident in the sensor SU.

The scan driver 400 may be connected with the scan signal lines G1, . . . , Gi, G(i+1), . . . and Gn of the touch panel 300. The scan driver 400 applies a scan signal Vg formed of a combination of a gate-on voltage Von capable of turning on the switching element of the sensor SU and a gate-off voltage Voff capable of turning off the switching element to the scan signal lines G1, . . . , Gi, G(i+1), . . . and Gn

The sensing signal processor 800 is connected with the sensing signal line ROj of the touch panel 300. The sensing signal processor 800 includes a circuit for reading out a sensing signal Vp from the sensing signal line ROj and converting the amount of charge generated in the sensor SU into a voltage. The sensing signal processor 800 AD-converts (converts the analog voltage to a digital signal) the converted voltage to generate a digital sensing signal.

The touch determining unit 900 may determine whether the touch has occurred and the position of the touch by receiving the digital sensing signal from the sensing signal processor 800 and performing a calculation on the received digital sensing signal. Touch information, such as whether the touch is generate, the touch position, and an image of an object, is then generated.

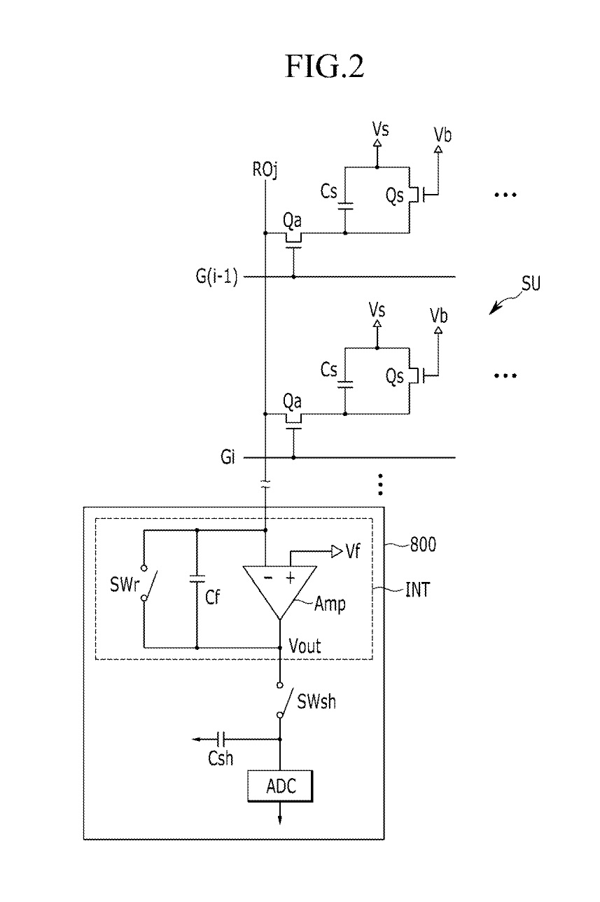

A more detailed structure of the sensor and the sensing signal processor according to an exemplary embodiment will be described with reference to FIG. 2 together with FIG. 1.

FIG. 2 is a circuit diagram of the sensor and the sensing signal processor according to an exemplary embodiment.

Referring to FIG. 2, the sensor SU according to an exemplary embodiment includes switching elements Qa, and sensing elements Qs and sensing capacitors Cs connected with the switching elements Qa.

The switching elements Qa are three-terminal elements, such as a thin film transistor. Control terminals of the switching elements Qa are connected with the scan signal lines Ga(i−1) and Gi, output terminals of the switching elements Qa are connected with the sensing signal line ROj, and input terminals are connected with the sensing element Qs and the sensing capacitor Cs. The switching elements Qa are turned on upon application of the gate-on voltages Von to the scan signal lines Ga(i−1) and Gi, and send sensing signals to the sensing signal line ROj, and charge the sensing capacitor Cs with the reference voltage Vf.

The sensing element Qs is a three-terminal element, such as a thin film transistor. An input terminal of sensing element Qs receives a source voltage Vs, a control terminal of sensing element Qs receives a bias voltage Vb, and an output terminal of sensing element Qs is connected with the switching element Qa. The bias voltage Vb may be a voltage sufficiently low or high in relation to the gate-off voltage so that the sensing element Qs maintains an off-state when light is not irradiated on the sensing element Qs. The sensing element Qs may include a photoelectric material generating a light (leakage) current when light is irradiated. An example of the sensing element Qs may be a thin film transistor having a channel including at least one of amorphous silicon, amorphous germanium (a-Ge), amorphous silicon-germanium (A-SiGe), and polysilicon capable of generating photoelectric current.

Two terminals of the sensing capacitor Cs are connected with the switching element Qa and the source voltage Vs, respectively. The sensing capacitor Cs may be charged with the reference voltage Vf applied to the sensing signal line ROj according to the scan signals of the scan signal lines Ga(i−1) and Gi, or be discharged by the photoelectric current of the sensing element Qs.

The sensing signal processor 800 according to an exemplary embodiment may include an integrator INT connected to each sensing signal line ROj, a sample and hold switch SWsh, a sample and hold capacitor Csh, and an analog to digital (AD) converter ADC. The integrator INT, the sample and hold switch SWsh, and the sample and hold capacitor Csh may form a readout circuit of the sensing signal, that is, a circuit for converting the amount of charges changed in the sensor SU to a voltage, together.

Each integrator INT, which is a current integrator, includes an amplifier Amp having an inversion terminal (−), a non-inversion terminal (+), and an output terminal, and a capacitor Cf and a reset switch SWr connected to the amplifier Amp. The inversion terminal (−) of the amplifier Amp is connected with the sensing signal line Roj, and the capacitor Cf and the reset switch SWr are connected between the inversion terminal (−) and the output terminal. The non-inversion terminal (+) of the amplifier (Amp) is connected to the reference voltage Vf.

The sample and hold switch SWsh is connected between the output terminal of the amplifier Amp and the AD converter ADC, and the sample and hold capacitor Csh is connected between the sample and hold switch SWsh and the AD converter ADC.

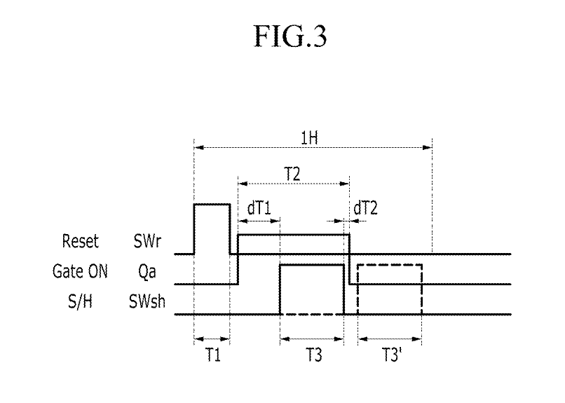

A driving method of the touch sensing device including the sensor according to an exemplary embodiment will be described with reference to FIGS. 3 to 5 together with aforementioned FIGS. 1 and 2.

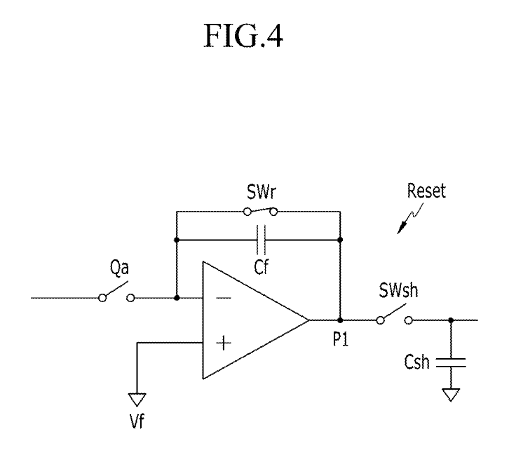

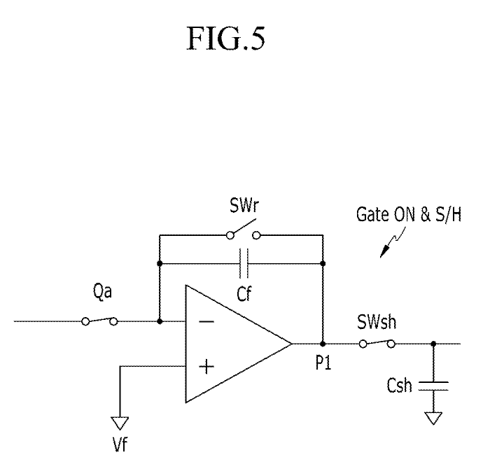

FIG. 3 is a waveform diagram of a driving signal of the sensor and the sensing signal processor according to an exemplary embodiment, FIG. 4 is a circuit diagram of a reset step of the sensor and the sensing signal processor according to an exemplary embodiment, and FIG. 5 is a circuit diagram of an output step of the sensor and the sensing signal processor according to an exemplary embodiment.

First, referring to FIGS. 1 and 2, when the scan driver 400 sequentially applies the gate-on voltage Von to the scan signal lines G1, . . . , Gi, G(i+1), . . . and Gn during one frame at 1 horizontal period (1H), the switching elements Qa connected to the scan signal lines G1, . . . , Gi, G(i+1), . . . and Gn to which the gate-on voltage Von is applied are sequentially turned on. FIG. 3 illustrates an exemplary signal waveform during 1 horizontal period (1H) which includes a time for which the gate-on voltage Von is applied to one scan signal line Gi.

Referring to FIGS. 2, 3, and 4, the reset switch SWr of the integrator INT is turned on during a first period T1 to reset the capacitor Cf. The period is referred to as an Amp reset (Reset) period. In Amp reset (Reset), voltages at both ends of the capacitor Cf are initialized to the reference voltage Vf. Also in the Amp reset (Reset), the switching element Qa of the sensor SU and the sample and hold switch SWsh of the sensing signal processor 800 are in a turned-off state. The reset switch SWr may be turned on with a period of a predetermined time duration, and the period may be 1 horizontal period (1H).

Next, referring to FIGS. 2, 3, and 5, after the Amp reset (Reset) ends, at the end of period T1, the switching element Qa of the sensor SU is turned on in the second period T2. This period is referred to as a reset and output (Gate On) of the sensor SU. In the reset and output (Gate On) of the sensor SU, the reference voltage Vf, which is transferred by the sensing signal line ROj, is transferred to one terminal of the sensing capacitor Cs of the sensor SU, and the sensing capacitor Cs is charged by a difference between the reference voltage Vf and the source voltage Vs. In this case, the sensing signal may be output to the sensing signal line ROj from the sensor SU during the turning-on of the switching element Qa. An output operation of the sensing signal will be described below in more detail.

The switching element Qa is turned off while the gate-off voltage Voff is applied to the switching element Qa. When the sensor SU receives a touch, for example, when light is irradiated to the sensing element Qs by a touch of an exterior object while the switching element Qa is turned off, photoelectric current is generated in the sensing element Qs. Then, a voltage drop occurs in a terminal to which the reference voltage Vf of the sensing capacitor Cs has been applied, so that the sensing capacitor Cs is discharged. In the meantime, when light is not irradiated to the sensing element Qs because a touch of an exterior object and the like is not generated, the sensing capacitor Cs is not discharged. This action is referred to as a sensing step of the sensor SU. The period except for the reset and output (Gate On) of the sensor SU, as illustrated in FIG. 3, may correspond to the sensing step of the sensor SU.

At the time the sensor SU enters the reset and output period in a next frame following the sensing step of the sensor SU, and thus the switching element Qa is turned on, the reference voltage Vf is transferred to the sensing capacitor Cs through the turned-on switching element Qa in a case where a charging voltage of the sensing capacitor Cs is changed due to a touch in a previous sensing step, so that the sensing capacitor Cs of the sensor SU is recharged. In this case, a current is generated in the sensing signal line ROj so that a sensing signal is generated, and the sensing signal is input in the sensing signal processor 800. Then, the integrator INT of the sensing signal processor 800, which is a current integrator, integrates a current of the sensing signal to charge the capacitor Cf.

In the reset and output (Gate On) period of the sensor SU, a sensing output voltage Vout, which is a voltage of an output terminal P1 of the amplifier Amp, is changed according to the amount of charges transferred to the capacitor Cf of the integrator INT. For example, when it is assumed that the amount of charges transferred to the capacitor Cf of the integrator INT is Q and a capacitance of the capacitor CF is C, the sensing output voltage Vout may be changed by approximately Q/C.

According to related art, the sensing output voltage Vout stored in the capacitor Cf is transferred to the sample and hold capacitor Csh and the AD converter ADC through the turned on sample and hold switch SWsh during a third period T3′, which is indicated in dashes in FIG. 3, after the termination of the reset and output period Gate On of the sensor SU, and the sensing output voltage Vout is sampled and stored in the sample and hold capacitor Csh.

However, according to exemplary embodiments of the present disclosure, a second period T2, at which the reset and output step (Gate On) period of the sensor SU is located, includes a third period T3 in which the sample and hold switch SWsh of the sensing signal processor 800 is turned on. That is, the switching element Qa of the sensor SU and the sample and hold switch SWsh of the sensing signal processor 800 connected to the scan signal line Gi to which the gate-on voltage Von is applied are simultaneously turned on during a third period T3. During the third period T3, the charging of the capacitor Cf of the integrator INT by the sensing signal and the charging of the sample and hold capacitor Csh by the sensing output voltage Vout are simultaneously performed. The sensing output voltage Vout is sampled and charged in the sample and hold capacitor Csh, so that each sensing signal may be read out. This action is referred to as a sample and hold step (S/H).

Thus, according to exemplary embodiments of the present disclosure, the switching element Qa of the sensor SU is turned off and the readout operation of the sensing signal is simultaneously terminated, so that the amount of time for turning on the sample and hold switch SWsh is decreased as compared to the related art. Accordingly, it is possible to decrease the amount of time for reading out the sensing signal in the touch sensing device including the charge sensitive sensor, thereby being advantageous to a high-speed sensing operation and improving a touch feeling. Further, a degree of freedom capable of controlling a time of the reset and output (Gate On) period, which is the turned-on time of the switching element Qa of the sensor SU, is created by a decreased driving time, so that a time of the second period T2 may be sufficiently set.

According to exemplary embodiments, a time difference dT1, which is the amount of time between a start point of the third period T3 and a start point of the second period T2, and a time difference dT2, which is the amount of time between a termination point of the third period T3 and a termination point of the second period T2, are each larger than 0. More particularly, at least one of the time difference dT1 and the time difference dT2 may be equal to or larger than approximately 0.5 μs considering a driving margin. In particular, because a kick back effect may appear when the switching element Qa of the sensor SU is turned on, the start point of the third period T3 may maintain a predetermined time difference with the start point of the second period T2 in order to avoid a time at which the kick back progresses.

The duration of the third period T3 may be appropriately controlled in accordance with the condition of the touch panel 300.

According to exemplary embodiments, the kick back voltage is included as an offset output in the sensing output voltage Vout when the switching element Qa of the sensor SU is turned on, so that it is necessary to set the reference voltage Vf to be larger by at least the offset output for an accurate touch sensing result than a reference voltage used in the related art. Further, in a case where the touch panel 300 becomes large, a signal delay is increased, so that it is necessary to set the reference voltage Vf to be larger in order to compensate for an influence of the signal delay. For example, the reference voltage Vf may be set to in a range from approximately 2.7 V to approximately 3.3 V.

The sensing output voltage Vout charged in the sample and hold capacitor Csh according to exemplary embodiments is transferred to the AD converter ADC. The AD converter ADC AD converts the sensing output voltage Vout to generate a digital sensing signal.

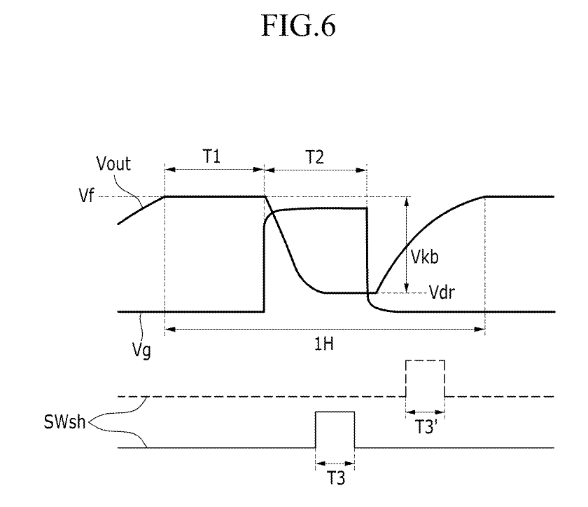

A sensing effect of the touch sensing device according to exemplary embodiments of the present disclosure will be described with reference to FIGS. 6 to 8 together with the aforementioned drawings.

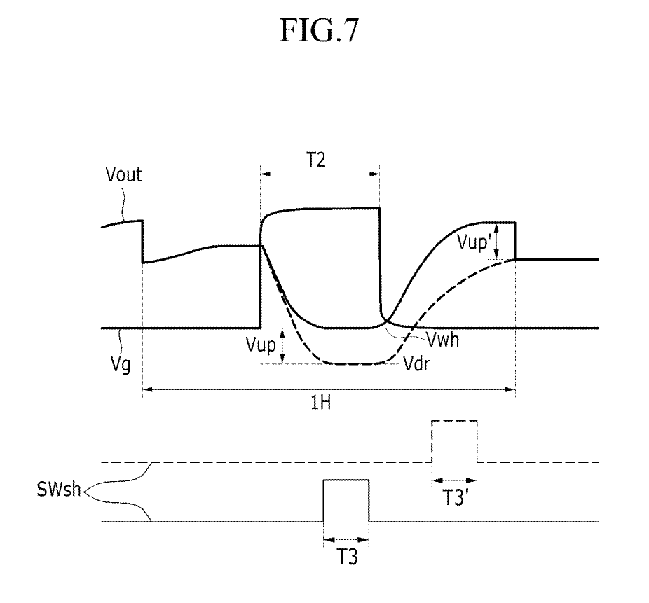

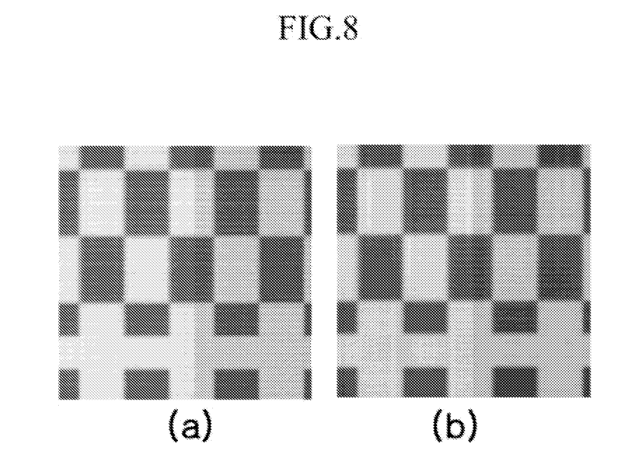

FIG. 6 is a waveform diagram of a driving signal and a sensing output signal of the sensor and the sensing signal processor in a case where the sensor is not irradiated with light, according to an exemplary embodiment, FIG. 7 is a waveform diagram of a driving signal and a sensing output signal of the sensor and the sensing signal processor in a case where light is irradiated to the sensor according to an exemplary embodiment, and FIG. 8 illustrates an image sensed by a sensor in the related art and an image sensed by the sensor according to an exemplary embodiment.

FIG. 6 illustrates a waveform of a driving signal for the 1 horizontal period (1H) under a condition in which the sensor SU is not irradiated with light (dark condition), that is, a condition in which approach or a touch of an exterior object to the sensor SU does not occur.

In an early phase of the 1 horizontal period (1H), the sensing output voltage Vout which is a voltage of the output terminal P1 of the amplifier Amp in the Amp reset (Reset) of the first period T1 is in a state of being reset to the reference voltage Vf.

When the reset and output (Gate On) of the sensor SU of the second period T2 starts, the scan signal Vg applied to the switching element Qa of the sensor SU becomes the gate-on voltage Von, so that the switching element Qa is turned on. At this time, the sensing output voltage Vout is changed by a kick back voltage Vkb by a turn-on kick back effect due to a parasitic capacitance between terminals of the switching element Qa. An example in which the sensing output voltage Vout is dropped by the kick back voltage Vkb in a case where the amplifier Amp of the sensing signal processor 800 is an inversion amplifier is illustrated.

Because there is no substantial change in the amount of charged charges of the sensing capacitor Cs of the sensor SU under the dark condition, even the amount of charges charged in the capacitor Cf of the integrator INT may not be substantially changed. After the turn-on kick back in the second period T2, the sensing output voltage Vout has a level of a dark voltage Vdr.

When the scan signal Vg applied to the switching element Qa of the sensor SU is dropped to the gate off voltage Voff, the second period T2 is terminated. In this case, the sensing output voltage Vout is also changed by a turn-off kick back effect due to the parasitic capacitance between the terminals of the switching element Qa. In this case, the sensing output voltage Vout approaches a level of the reference voltage Vf.

According to the related art, as illustrated with a dashed line of FIG. 6, the third period T3′ in the related art starts after the elapse of a predetermined time after the termination of the second period T2, and the sample and hold switch SWsh of the sensing signal processor 800 is turned on in the third period T3′ in the related art.

However, according to the exemplary embodiments of the present disclosure, the third period T3 in which the sample and hold step (S/H) progresses starts after the elapse of a predetermined time after the second period T2 starts, so that the sample and hold switch SWsh of the sensing signal processor 800 is turned on, and the third period T3 is terminated before the termination of the second period T2. Then, the sensing output voltage Vout at the level of the dark voltage Vdr is stored in the sample and hold capacitor Csh to be transferred to the AD converter ADC. Accordingly, it is possible to decrease a readout time of the sensing signal compared to the related art, thereby decreasing a time necessary for the sensing operation.

FIG. 7 illustrates a waveform of a driving signal for the 1 horizontal period (1H) under a condition where the sensor SU is irradiated with light (white condition), that is, a condition in which approach or a touch of an exterior object to the sensor SU does occur.

Similar to the dark condition, in an early phase of the 1 horizontal period (1H), the sensing output voltage Vout which is a voltage of the output terminal P1 of the amplifier Amp in the Amp reset (Reset) of the first period T1 is in a state of being reset to the reference voltage Vf.

When the reset and output (Gate On) of the sensor SU of the second period T2 starts, the scan signal Vg applied to the switching element Qa of the sensor SU becomes the gate-on voltage Von, so that the switching element Qa is turned on. At this time, the sensing output voltage Vout is changed by the kick back voltage Vkb by the kick back effect due to the parasitic capacitance between the terminals of the switching element Qa.

Together with this, there is a substantial change in the amount of charged charges of the sensing capacitor Cs of the sensor SU under the white condition, so that the amount of current of the sensing signal is increased in proportion to the amount of change, and the amount of charges charged in the capacitor Cf of the integrator INT is also substantially changed in proportion to the increase in the amount of current of the sensing signal. Accordingly, the sensing output voltage Vout after the turn-on kick back in the second period T2 has a level of a white voltage Vwh which may be higher or lower than the level of the dark voltage Vdr. FIG. 7 illustrates an example in which the white voltage Vwh is higher than the dark voltage Vdr. A voltage difference Vup between the white voltage Vwh and the dark voltage Vdr may be substantially proportionate to the amount of irradiation of light sensed by the sensor SU.

When the scan signal Vg applied to the switching element Qa of the sensor SU is dropped to the gate off voltage Voff, the second period T2 is terminated. In this case, the sensing output voltage Vout is also changed by a turn-off kick back effect due to the parasitic capacitance between the terminals of the switching element Qa. In this case, the sensing output voltage Vout approaches a level higher than the reference voltage Vf.

According to the related art, as illustrated with a dashed line (light) of FIG. 7, the third period T3′ in the related art starts after the lapse of a predetermined amount of time after the termination of the second period T2, and the sample and hold switch SWsh of the sensing signal processor 800 is turned on in the third period T3′ in the related art. In this case, a degree of the touch, whether the touch is generated, and the like may be determined by using a voltage difference Vup′ between the sensing output voltage Vout stored in the sample and hold capacitor Csh under the white condition, and the sensing output voltage Vout obtained under the dark condition.

However, according to the exemplary embodiments, the third period T3 starts after the lapse of a predetermined amount of time after the second period T2 starts, so that the sample and hold switch SWsh of the sensing signal processor 800 is turned on, and the third period T3 is terminated before the termination of the second period T2. Then, the sensing output voltage Vout at the level of the white voltage Vwh is stored in the sample and hold capacitor Csh to be transferred to the AD converter ADC. In this case, a degree of the touch, whether the touch is generated, and the like may be determined by using a voltage difference Vup between the sensing output voltage Vout stored in the sample and hold capacitor Csh under the white condition, and the sensing output voltage Vout obtained under the dark condition.

In order to accurately obtain touch information, such as the degree of the touch, by using the voltage difference Vup between the sensing output voltage Vout stored in the sample and hold capacitor Csh under the white condition and the sensing output voltage Vout obtained under the dark condition, a position and a length of the third period T3 may be appropriately controlled. For example, the position of the third period T3 may be controlled so as to be aligned with the period in which the voltage difference Vup is noticeably exhibited, and the length of the third period T3 may be controlled so as to sufficiently sample the voltage difference Vup.

The voltage difference Vup between the sensing output voltage Vout under the white condition and the sensing output voltage Vout under the dark condition in the second period T2, which is a period in which the switching element Qa of the sensor SU is turned on, is substantially the same as, or at least proportional to, the voltage difference Vup between the sensing output voltage Vout under the white condition, and the sensing output voltage Vout under the dark condition after the second period T2, which is a period in which the switching element Qa of the sensor SU is turned off.

Accordingly, the touch information obtained by using the sensing output voltage Vout sampled in the second period T2 before the switching element Qa of the sensor SU is turned off may be substantially the same as the touch information obtained by using the sensing output voltage Vout sampled after the switching element Qa of the sensor SU is turned off, which is similar to the related art.

FIG. 8A illustrates an image according to the touch information obtained according to the related art, and FIG. 8B illustrates an image according to the touch information obtained by the driving method of the touch sensing device according to an exemplary embodiment. Referring to FIGS. 8A and 8B, it can be seen that the image according to the touch information obtained according to an exemplary embodiment is almost the same as the image obtained according to the touch information according to the related art.

When the touch information is obtained through the charge sensitive sensor, an absolute value of the amount of charges sampled in the sample and hold capacitor Csh is not used, but the difference between the amount of charges sampled under the white condition and the amount of charges sampled under the dark condition, that is a relative value, is used. Accordingly, even though the voltage difference Vup between the sensing output voltage Vout under the white condition and the sensing output voltage Vout under the dark condition in the second period T2 is different from the voltage difference Vup′ between the sensing output voltage Vout under the white condition and the sensing output voltage Vout under the dark condition after the second period T2, because it is a relative value that is measured, the same touch information may be obtained.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the disclosure, including the appended claims.

<Description of symbols>

| | |
|---|---|
| 300: Touch panel | 400: Scan driver |
| 800: Sensing signal processor | 900: Touch determining unit |
| ADC: AD converter | Amp: Amplifier |
| Cf: Capacitor | Cs: Sensing capacitor |

| | |
|---|---|
| Csh: Sample and hold capacitor | INT: Integrator |

| | |
|---|---|
| Qa: Switching element | Qs: Sensing element |
| SU: Sensor | SWr: Reset switch |

| | |
|---|---|
| SWsh: Sample and hold switch | Vf: Reference voltage |

Vout: Sensing output voltage

What is claimed is:

1. A method of driving a touch sensing device, the touch sensing device including a sensor including a switching element, a sensing signal line connected with the sensor, an amplifier connected with the sensing signal line, a reset switch and a capacitor connected between an input terminal and an output terminal of the amplifier, and a sample and hold switch and a sample and hold capacitor that are connected to the output terminal of the amplifier, the method comprising:
outputting a sensing signal to the sensing signal line by turning on the switching element during a first period according to a scan signal; and
turning on the sample and hold switch during a second period occurring within the first period.

2. The method of claim 1, wherein:
a start point of the second period is later than a start point of the first period, and
a termination point of the second period is earlier than a termination point of the first period.

3. The method of claim 2, wherein:
at least one of a time difference between the start point of the second period and the start point of the first period and a time difference between the termination point of the second period and the termination point of the first period is equal to or larger than approximately 0.5 μs.

4. The method of claim 3, further comprising:
turning on the reset switch during a third period occurring prior to the start point of the first period.

5. The method of claim 4, wherein:
the reset switch resets both terminals of the capacitor with a reference voltage during the third period.

6. The method of claim 5, wherein:
the reference voltage is in a range from approximately 2.7 V to approximately 3.3 V.

7. The method of claim 6, wherein:
the sensor further includes a sensing element and a sensing capacitor that are connected with the switching element.

8. The method of claim 2, further comprising:
turning on the reset switch during a third period occurring before the start point of the first period.

9. The method of claim 8, wherein:
the reset switch resets both terminals of the capacitor with a reference voltage during the third period.

10. The method of claim 9, wherein:
the reference voltage is in a range from approximately 2.7 V to approximately 3.3 V.

11. A touch sensing device comprising:
a sensor including a switching element outputting a sensing signal according to a scan signal;
a sensing signal line connected with the switching element of the sensor and transfer the sensing signal;
an amplifier connected with the sensing signal line;
a reset switch and a capacitor connected between an input terminal and an output terminal of the amplifier; and
a sample and hold switch and a sample and hold capacitor that are connected to the output terminal of the amplifier,
wherein a second period in which the sample and hold switch is turned on occurs within a first period in which the switching element is turned on.

12. The touch sensing device of claim 11, wherein:
a start point of the second period is later than a start point of the first period, and
a termination point of the second period is earlier than a termination point of the first period.

13. The touch sensing device of claim 12, wherein:
at least one of a time difference between the start point of the second period and the start point of the first period and a time difference between the termination point of the second period and the termination point of the first period is equal to or larger than approximately 0.5 μs.

14. The touch sensing device of claim 13, wherein:
a third period in which the reset switch is turned on occurs prior to the start point of the first period.

15. The touch sensing device of claim 14, wherein:
the reset switch resets both terminals of the capacitor with a reference voltage during the third period.

16. The touch sensing device of claim 15, wherein:
the reference voltage is in a range from approximately 2.7 V to approximately 3.3 V.

17. The touch sensing device of claim 16, wherein:
the sensor further comprises a sensing element and a sensing capacitor that are connected with the switching element.

18. The touch sensing device of claim 12, wherein:
a third period in which the reset switch is turned on occurs before the start of the first period.

19. The touch sensing device of claim 18, wherein:
the reset switch resets both terminals of the capacitor with a reference voltage during the third period.

20. The touch sensing device of claim 19, wherein:
the reference voltage is in a range from approximately 2.7 V to approximately 3.3 V.
